(19) United States
(12) Patent Application Publication
(10) Pub. No.: US 2004/0019554 A1
(43) Pub. Date: Jan. 29, 2004

(54) Automated trading system

(76) Inventors: Michael S. Merold, Sparta, NJ (US); Snezhana Malkin, Morris Plains, NJ (US); Tracey Riordan, Bernardsville, NJ (US); Edward R. Howorka, Morris Plains, NJ (US)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/205,535

(22) Filed: Jul. 26, 2002

(51) Int. Cl. G06F 17/60

(52) U.S. Cl. 705/37

(57) ABSTRACT

This invention resides in receiving a price feed of data specifying prices of instruments to be traded and converting prices to quotes which specify a price at which a trade can be made and an amount for that trade. In particular, the invention resides in a quote submission interface that controls whether quotes should be derived and submitted from a price feed. In an embodiment of the invention, the quote submission interface determines whether quotes should be submitted based upon a variety of factors, including any combination of the frequency of price changes, the price level in comparison to a best price, the format of price messages, the net exposure as a result of automatic deal submission, and other factors.

### FIELD OF THE INVENTION

This invention relates to automated trading systems and, in particular, to real time systems, for example, for trading financial instruments. The invention is applicable, but not limited to anonymous trading systems.

### BACKGROUND OF THE INVENTION

Automated, or electronic trading systems have gained widespread acceptance in recent years. Many financial instruments and commodities are traded automatically. In the area of foreign exchange (FX), electronic trading systems account for most of the currency transactions performed in the markets in the major currency pairs.

FX electronic systems include conversational dealing systems, also known as direct dealing systems, and anonymous systems. In conversational systems, parties negotiate trades by exchange of messages. In anonymous trading systems, quotes are entered into the systems anonymously, that is without revealing their source, and are either matched automatically by the system or are hit or taken by other traders on the system. Only when a deal has been completed is the identity of the parties revealed.

A trading floor establishes credit lines (by setting limits) with possible counterparties to ensure that deals are not done with parties when the Institution does not wish to trade. An example of successful anonymous trading systems is the EBS system offered by EBS Dealing Resources Limited of London UK. Details of this system may be found in U.S. Pat. No. 5,375,055.

In the system mentioned above, traders input quotes and buy or sell orders into the system. An institution's trading floor will typically comprise a number of traders each interacting with the system via trader terminals, which include a display showing them at least the best prices in the market, together with a range of information about deals done on the system. Traders enter quotes, bids and offers into the system via a keyboard or a keypad, although other entry means such as a touch screen are possible.

We have appreciated that human traders represent a weak link in an otherwise fully automated dealing process. We have also appreciated that it is desirable to automate the functions performed by the traders. Traders represent a significant cost centre to institutions and are also liable to make costly mistakes. Automation in a request response system, where a request for a price is put out to the market is relatively simple. However, automation of real time systems, such as the EBS System mentioned above is considerably more difficult as the system has to respond to real time price information in the market.

We have further appreciated the technical problem of providing a safety arrangement to avoid unwanted quotes from being automatically submitted to a trading system. The automatic submission of quotes which do not make commercial sense would cause unwanted ‘best price’ information determined by an algorithm to be released to the market, and degrade the performance of an automated trading system by producing unnecessary message flows using network bandwidth and using processor time.

### SUMMARY OF THE INVENTION

The invention is defined in the claims to which reference is directed.

In a broad aspect the invention resides in receiving a price feed of data specifying prices of instruments to be traded and converting prices to quotes which specify a price at which a trade can be made and an amount for that trade. In particular, the invention resides in a quote submission interface that controls whether quotes should be derived and submitted from a price feed. In an embodiment of the invention, the quote submission interface determines whether quotes should be submitted based upon a variety of factors, including any combination of the frequency of price changes, the price level in comparison to a best price, the format of price messages, the net exposure as a result of automatic deal submission, and other factors.

### BRIEF DESCRIPTION OF THE FIGURES

Embodiments of the invention will now be described, by way of example, and with reference to the accompanying drawings, in which:

FIG. 1 is a representative example of an anonymous trading system;

FIG. 2 shows a price feed arrangement for the trading system of FIG. 1;

FIG. 3 shows the components of a quote submission interface according to a first embodiment of the invention;

FIG. 4 shows the components of the quote submission interface of FIG. 3 in greater detail;

FIG. 5 shows the components of a second embodiment of the invention;

FIG. 6 shows a quote submission parameter store and the main parameter store locations; and

FIG. 7 shows the main quote submission process.

### DESCRIPTION OF A PREFERRED EMBODIMENT

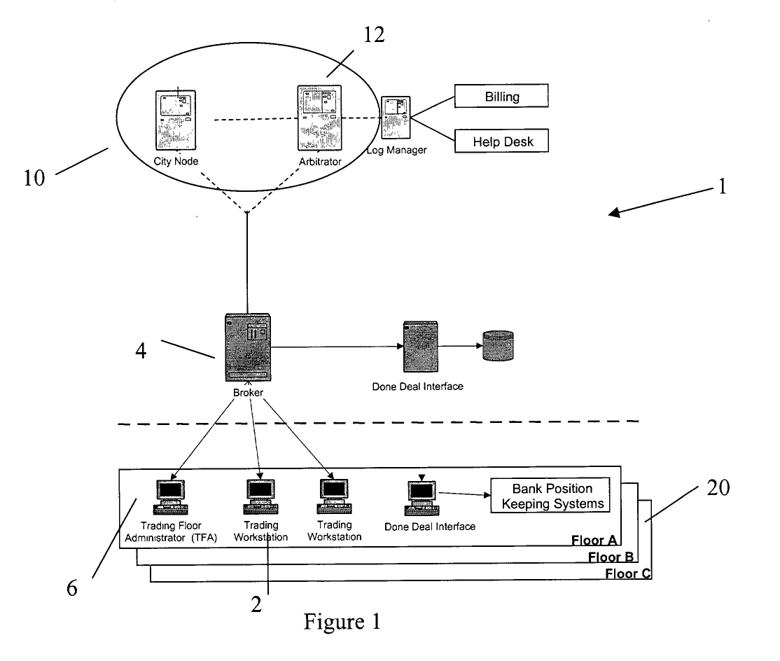

The system shown in FIG. 1 is a representative example of a trading system 1 in which the present invention could be implemented. However, it is stressed that the invention is not restricted to that example and is applicable to any real time automated trading systems, whether or not it is anonymous. The example of FIG. 1 is given purely for ease of understanding of the present invention.

The invention is applicable to any financial instrument that may be traded on a computer trading system, such as foreign exchange, commodities, stocks/shares, futures and any other such instruments. The example described herein will be foreign exchange.

Matching System

In the system of FIG. 1, dealers input, via a keypad or keyboard, messages into the system. The dealers are logically grouped as trading floors 20 that are typically banks or other such organisations, such that the dealers trade with other dealers at other such trading floors. The term “trading entity” is used herein to refer generally to an individual trader, a trading floor or a financial institution, such as a bank.

To initiate a trade, a “quote” is submitted. A quote is an instruction to bid or offer a specified amount of an instrument at a specified price. These are submitted by traders at the trader workstations 2 and are transmitted to a deal matching system 10 as quote messages. Quote messages are distributed throughout the system and are made visible to other dealers as part of market views. In response to a price shown for a quote dealers may submit “orders” in response to attempt to match all or part of a quote at the price shown. Orders are instructions to buy or sell and are transmitted throughout the system as order messages. Orders are invisible in the sense that they are not shown to other dealers. An invisible order is also known as a “hit” in which a trader agrees to buy or sell to match a quote that is visible in the system. The trader's terminal displays the best prices in the market and, when those prices move to a value at which the trader wishes to buy or sell, the trader must “hit” the price before any other trader in order to secure the deal. The matching of bids and offers is performed by a matching system 10 that includes an arbitrator 12. The arbitrator matches quotes and orders based on price and time priority. This means that where there are two quotes in the system at the same price, the quote submitted first will be matched with an appropriate order. A quote at a better price is matched in preference to one at a worse price. A trading floor administrator workstation 6 is provided to allow an administrator to set various parameters, such as credit with counterparties, governing how and with whom traders on their associated trading floor may trade.

The system includes one or more broker nodes 4 whose functions include quote and buy/sell orders validation and market view generation. The broker nodes store details of credit limits for traders between the trading floor and other institutions or trading floors of institutions in the system. Before a deal can be completed a credit check is made to ensure both parties have sufficient credit to complete the deal. If they do not, the deal amount may be reduced or the deal cancelled altogether.

The broker nodes 4 also distribute market prices to the trader terminals. These prices are screened for credit so that traders are only shown prices from counterparties with whom they have credit. This prevents traders hitting a price only to find that the deal cannot be completed due to lack of credit. The credit pre-screen is performed with reference to the yes/no matrix held at the broker node.

In practice, the system includes at least one arbitrator 12 for each of the three major trading regions, USA, Europe and Asia. Deals will usually be handled by the local arbitrator, with both parties located in the same geographical area but deals can take place between counterparties located in different regions in which case deal related messages are passed from one arbitrator to the next.

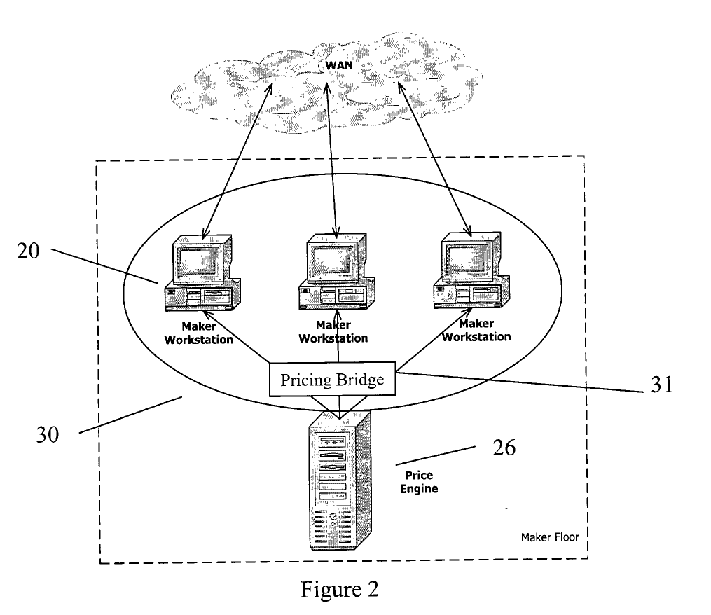

The present embodiments of the invention resides at the interface between prices and the submission of quotes into a trading system. This can be seen logically in FIG. 2 as interface 30. The interface 30 acts as a bridge between the price engine 26 and workstations 20.

In known systems, traders receive price information from a number of sources. In many institutions, a price engine 26 gathers prices for instruments from a number of sources and creates a general price for an instrument. Traders use this price as a guide as to the price at which quotes should be submitted and have discretion as to how and when quotes or orders should be entered into the system using the workstations 20. The interface between prices and quote submission in the present embodiment is shown as interface 30. In the present embodiment this quote submission interface is a direct computer link rather than traders. The interface may include a server computer shown here as pricing bridge 31.

There are two aspects to the functionality of the quote submission interface:

1. The conversion of prices to quotes; and

2. The feeding of quotes directly into the trading system.

There are also two alternative models by which this functionality is achieved.

A. The first implementation of the quote submission interface is by combining the functions of quote to price conversion, and manual initiation of the automatic quote submission, functions as a price feed interface application (PFI) and a workstation (that supports manual quote and buy/sell order submission), here shown logically as combined at each workstation 20.

B. The second preferred implementation of the quote submission interface separates the two functions into a liquidity feed (LF) unit providing price to quote conversion and a separate automated trading interface (ATI) to submit quotes and eventually buy/sell orders to the matching system.

The quote submission interface takes a direct feed of prices. Whilst the prices could be manually provided to the Price to Quote/Buy-Sell Order Converter, prices are typically calculated by price engine 26 at a trading entity. The price engine could be also combined with the quote submission interface.

Price Engine

A price engine is known to the skilled person, but is described now for completeness. The function of the price engine 26 shown in FIG. 2 is to use market information supplied thereto to generate a general price for each trade type for each instrument dealt by a market maker. The general price can be derived using the market maker's own requirements.

Market Pricing Messages are received by the price engine from a variety of sources such as third parties who monitor market prices for that sector and supply the results to the market generally, sources such as the EBS Ticker Feed, or custom feeds supplied by banks. Trading entities may also supply to their own price engine proprietary Market Pricing Messages.

In general, market price messages may be supplied in a non-standard format. The price engine 26 must, therefore, standardise (normalise) the Market Pricing Messages before the data contained therein can be cleansed and averaged. For example, data in one Market Pricing Message may specify prices for USD/JPY whilst another Market Pricing Message may specify prices for $/JPY. Normalisation is achieved by converting the Market Pricing Messages into a standard format so that prices relating to a single instrument/transaction type can be compared. Once standardised, the Market Price Messages are separated according to instrument/transaction type. Prices for one instrument/transaction type are filtered to remove outliers. The filtered data is then averaged to generate a general price for each instrument and transaction type.

Market makers who opt to do so may additionally specify the filter parameters used in the filtering operation of the pricing unit to take account of, for example, market activity, supported instruments and market Maker defined pricing frequency and counterparty information.

Market Pricing Messages may be received at different intervals from different sources. The price engine 26 may therefore weight the price data from different Market Pricing Messages, applying a greater weighting to prices in the latter part of the period on the basis that these are more recent and therefore more likely to reflect current market status before the average, general price, is generated. The averaging algorithm may therefore be controlled by the dealer/trading floor submitting quotes (market maker) and may be used globally by the market maker for all instruments, or different algorithms may be defined for each currency pair traded by the market maker.

Once an average price for an instrument has been created, this is passed to the quote submission interface.

Quote Submission Interface

The quote submission interface 30 automatically generates quotes from price messages. Each automatically generated quote includes data specifying the quote price, whether the price is a buy or a sell price, identification of the instrument for which the price is quoted, the amount or value of the particular instrument that the market maker is prepared to trade and potentially other data (e.g. price for a specified amount range, time to live for the price, etc).

Generating quotes automatically without unnecessary dealer intervention benefits market makers by freeing their dealers to handle other transactions. The supply of automated quotes by market makers also helps to ensure that the automated trading system is liquid, offering (near) continuous opportunities to market users to initiate trades. Liquidity is helped by motivating market makers to provide automated quotes and by motivating market makers to specify higher amounts in their price parameters. The pricing structure of subscription to the automated trading system may be adjusted to help maximise liquidity.

Automatically generated quotes are communicated to the matching system 10 if various criteria are met. The criteria for generation of the quote and submission to the matching system are described below.

The quote submission interface is configured to allow a dealer to specify parameters that control the process of generation and submitting of a quote. The parameters control the timing, frequency, amount and prices of quotes submitted and potentially other attributes such as ‘time to live’ for the price.

Description of the First Embodiment

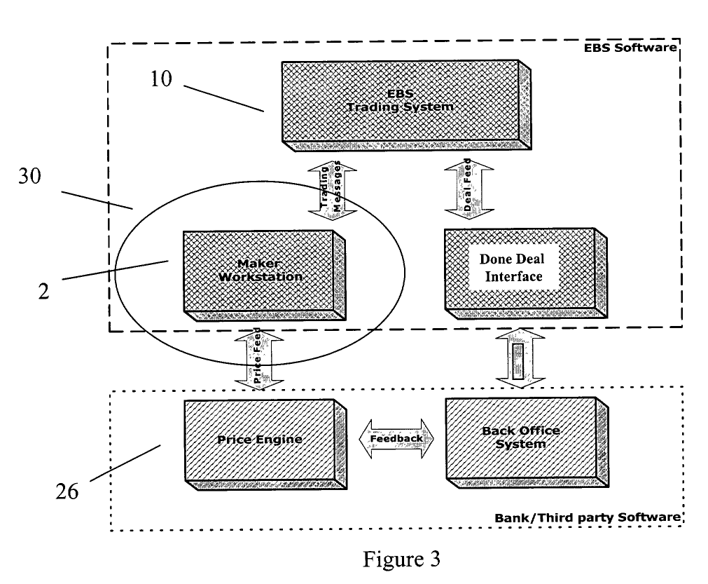

The quote submission interface 30 will first be described, with reference to FIG. 3, in the first model, namely implementing the interface on a trader workstation.

When a Dealer signs on to a Workstation 2, the workstation 2 automatically connects to the Price Engine 26 (optionally via the Price Feed Bridge 31). The Workstation then requests price subscriptions for all currency pairs established in a Trader Profile. The Price Engine 26 notifies the workstation 2 of accepted and rejected currency pair subscriptions. The Price Engine 26 supplies the workstation 2 with dual-sided prices for all accepted subscribed currency pairs. These are sent as price messages specifying a market price for a given instrument, in this example for a foreign exchange currency pair.

The Workstation 2 performs several ‘sanity checks’ on the prices. These sanity checks depend upon parameters set by traders as mentioned above. Depending on the outcome of the price validation, the price is:

A. Accepted,

B. Rejected and the automatic quote submission is suspended for that currency pair until the next valid price,

C. Rejected and the automatic quote submission is terminated for that currency pair until the PF Administrator/Trader reinitiates the automatic quote submission or

D. Rejected and the EBS MakerTaker Workstation disconnects from the Pricefeed.

On the Workstation 2, the Price Feed Administrator/Dealer configures the amount and the bias for each currency pair that is a candidate for automatic quote submission.

The Price Feed Administrator/Dealer initiates automatic quote submission at the workstation to the trading system 10 for selected currency pairs that are receiving Price feed prices. Once the automatic quote submission has been initiated, the Workstation automatically submits quotes based on the incoming price and the bias.

In broad terms, the quote submission interface and matching system together provide an arrangement to perform the following quote submission functions.

The arrangement automatically cancels the current quote(s) for a currency pair when the Workstation 2 receives valid price updates from the Price Feed (that contain prices different from the previous price update), and submits new quotes.

The arrangement automatically cancels the current quote for a currency pair when the quote amount falls below a given amount e.g. one million.

The workstation 2 will submit a new order every time a new valid price that is different from the previous price, is received. If multiple new valid prices are received within a time period, such as one second, then the most recent valid price received only is converted to a quote and transmitted as a quote message. Every new quote is submitted for a default amount configured by the trader on the workstation.

The arrangement can automatically maintain only two active orders per currency pair (one for each side of the market).

The arrangement automatically cancels the outstanding unmatched amount of a Pricefeed quote when:

1. a new price that is different from the previous price, is received by the workstation, or

2. the remaining order amount falls below a million units of the order's base currency.

It is noted that the functions discussed above may be implemented by the workstation issuing commands to the trading system 10, by the trading system automatically performing actions, or a combination of both.

As previously mentioned, the workstation allows traders to configure a bias (for example:_expressed in pips, percentage points etc) for each side of the market for each currency pair that will be automatically added or subtracted from the corresponding market price received from the price engine every time a new order is created based on preset parameters. These and other parameters will be described later.

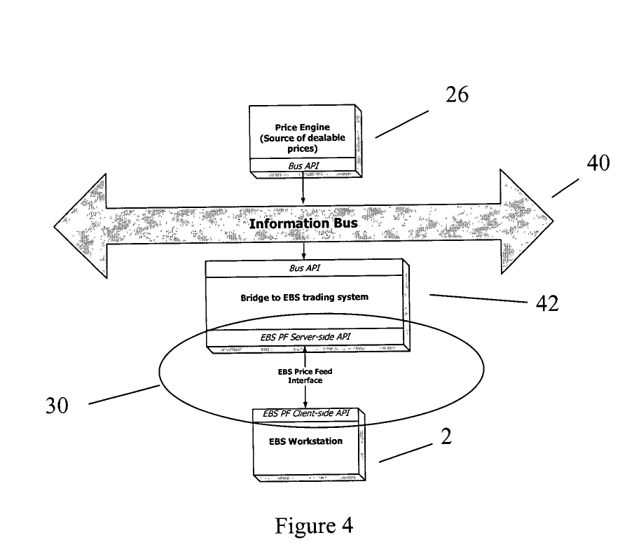

FIG. 4 shows an overview of the integrated system architecture that uses a quote submission interface, here called a price feed (PF) interface, to deliver prices from a bank-owned price source (a price engine) to a workstation. Only major components of the integrated system are shown on the diagram. The exact implementation may vary for different banks because of corporate infrastructure and technology polices.

In order to use Price Feed Interface 30, a trader/trading floor must have a local source of dealable prices that is accessible over the local corporate infrastructure. In general, price information is generated by a Price Engine 26 and is distributed via the corporate infrastructure using some type of Information Bus 40. In this type of environment the PF interface 30 is deployed by a Bridge component that picks up pricing data from the Information Bus and sends it to a workstation 2. Note that the Information Bus is not required—the Price Feed interface could be called directly from the Price Engine 26.

The three major physical components of the integrated architecture are:

1. Price Engine 26

2. Bridge 42

3. workstation(s) 2

As part of the integrated architecture, each component must perform certain component-specific functions. The Price Engine 26 component must continuously generate dealable prices for an instrument.

The Bridge component 42 must be able to receive a continuous feed of dealable prices from the Price Engine 26 and forward them to workstation(s) using the Price Feed interface.

The price feed interface application at the workstation is responsible for creating quotes based on received prices and trader-defined information (amount and bias), performing price validation and net position validation as well as submitting these quotes for matching into the Broker 4 (shown in FIG. 1).

The Workstation application shall calculate customer's net exposure throughout the session.

The net position limit is the total amount traded in a single currency pair taking into account the sides of the market over a Bank defined Net Position Time Interval. The Net Position is calculated as:

|D_{b}−Dₒ|+|Q_{b}−Qₒ|+|P_{b}−Pₒ|

where D_{b} is the sum of done Deals on Bid side, Dₒ is the sum of done Deals on Offer side, Q_{b} is the sum of active quotes on bid side, Qₒ is the sum of active Quotes on Offer side, P_{b} is the potential (about to be submitted) Quote on Bid side, Pₒ. is the potential (about to be submitted) Quote on Offer side.

Note that calculations should be done for a specific time interval and for a specific currency pair.

The Net exposure shall not exceed the net limit 110 per time interval 113 set in configuration file at any time during the session.

The following functionality is shared among the different components:

User authentication and entitlements;

Detecting communication failures;

Price information validation.

Each component must perform its part of the common functionality to allow the entire system to work according to business rules and maintain security and robustness.

The price feed interface 30 and the trading workstation 2 support their part of common functionality in terms of user authentication and failure detection.

The trading floor/trader is responsible for configuring the Price Engine to provide dealable and timely prices to the Workstation. The Price Feed application validates only the frequency at which prices are received and the price format, and disallows inverted and extreme off-market prices.

The Price Feed interface application monitors communication and connection integrity between the workstation(s) and the Bridge component (or other component that uses the Price Feed API). The workstation will cancel all active quotes when a communication failure or connection termination is detected. The workstation will automatically try to re-connect, re-subscribe and reinitiate automatic quote submission if an order submission was interrupted by the communication failure or connection termination.

The Price Feed interface limits the maximum delay between price updates for every currency pair. This is done to ensure a continuous stream of price updates during periods when dealable prices remain unchanged due to market conditions. The maximum delay limit is available through the Pricefeed API.

The Price Feed indirectly limits the minimum delay between price updates for the same currency pair by defining the maximum number of updates within a pre-defined time interval. This is done to avoid frequent price changes on the maker side that would prevent takers from initiating and completing a deal. As previously noted, when price updates occur more frequently than once a second but less frequently than the Maximum Number of Price Updates limit, the system uses the most recent validated price within that second.

The workstation will perform price validation on each price update value. It will validate the currency pair abbreviations. It will also verify that the received price is a valid number (is numeric and has correct format), that the number of decimals received matches EBS currency definitions and that two-sided prices are not inverted.

If any price validation rule is violated for any currency pair, the workstation will cancel all quotes for all active currency pairs, disconnect from the source of prices and wait for manual trader input before resuming automatic trading.

Description of the Second Embodiment (Best Mode)

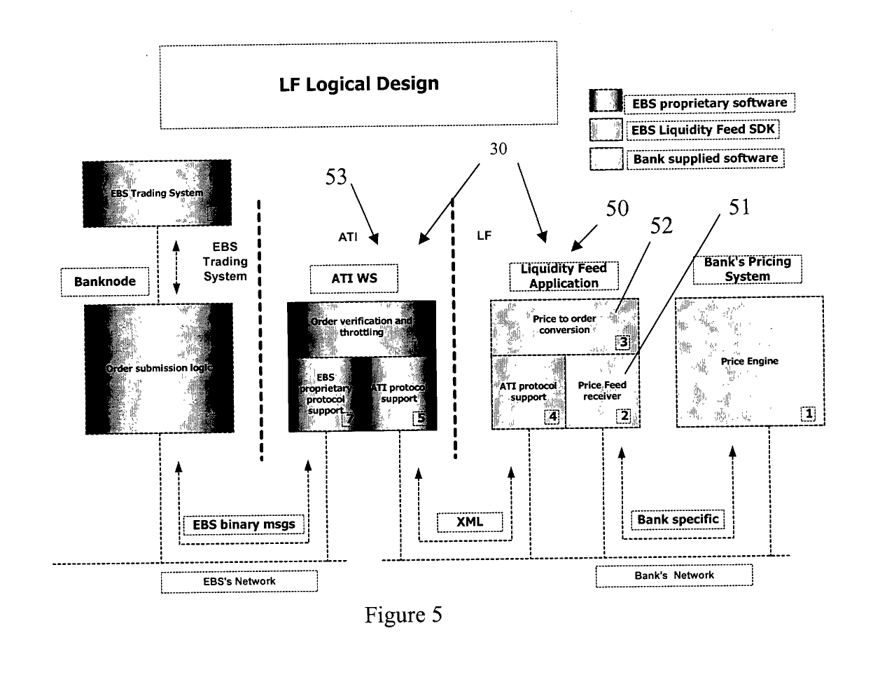

The second embodiment is shown in FIG. 5, and implements similar functionality as previously described, but divides the functionality between different physical components. The quote submission interface 30 is divided into two components: a liquidity feed application 50 configurable by a trading entity that converts price messages to quote messages; and an automated trading interface (ATI) 53 that receives quote messages and submits them to the matching system and, significantly, also receives data from the matching system to provide to the trading entity.

The component called Liquidity Feed 50 is an application that can be configured by trading floors using various parameters mentioned before and described in greater detail later. This application consists of the following parts:

Price Feed Receiver 51 is responsible for subscribing to bank's internal price feed and receiving constant stream of dealable prices supplied by bank's internal Price Engine. The implementation of this portion may differ from trading floor to trading floor because each bank uses its own price distribution system.

Liquidity Feed API 52 that includes a set of functions which the Liquidity Feed application 50 can call in order to open/close trading session, submit prices, receive notification about active deals and errors. Internally the Liquidity Feed API software 52 performs the following functions: price verification, convert prices to quotes, generate corresponding quote messages to submit quotes and pass deal notification and errors back to client's system.

The component called Automated Trading Interface (ATI) Workstation (WS) 53 is an application that is maintained by the provider of the matching system 10. The ATI WS 53 need not be a physical workstation and could be an application that communicates directly with the matching system. This application is responsible for communicating between the Trading entity and the matching system using XML and binary messages. In addition to message translation, this application also acts as a protection system, i.e. it will verify quotes received via ATI before submitting them for matching and it will throttle quotes (by rejecting them) when necessary to reduce quote processing load and to maintain performance of back-end components. ATI workstation logs every instruction being sent/received via ATI.

The arrows and numbers on FIG. 5 show stages through which a price message must go before it becomes a quote message. Note that all the protocols support two-way communication and as soon as a price becomes a quote, quote status information will be passed all the way back to the Liquidity Feed API that provided the dealable price which was used to create this quote.

The (liquidity feed) LF API 52 logic is responsible for:

Maintaining liquidity according to defined parameters, specified by customer (such as volume limits, net and gross exposure) and received prices.

Converting every quote submit request (generated by liquidity maintenance logic) into XML message according to ATI interface specification and sending it to the ATI workstation 53.

Interrupting quotes on request from the Trading entity

Accepting market views, quote/deal notifications and errors from the ATI workstation via ATI protocol and delivering this information to the bank's portion of the application using callbacks.

Disconnecting the Trading entity from the ATI application ie disconnecting the session, when an invalid price is received from the Price Engine.

Applying updated configuration parameters to the Liquidity Feed API.

A defined algorithm and parameters in the LF API 52 controls the amount of liquidity provided by the trading floor for the specific instrument at any point in time. That algorithm maintains an amount available as quotes submitted to the system as user specified minimum and maximum.

The Trading entity is responsible for setting the price level at which the amount is available, and for withdrawal of quotes from the market when a user decides to interrupt the Liquidity Feed.

The LF API 52 contains safety features such as enforcement of gross and net limits per time interval. These limits allow LF trading entities to control rate and side of the market at which liquidity is introduced into the matching system.

In order to provide liquidity for an instrument, a trading entity is required to maintain active quote(s) for that instrument in the matching system.

In order to use the LF Application the Bank's trading floor administrator (TFA) must first create a Trader account for the ATI WS.

The Bank's Pricing System generates and supplies prices to the LF Application.

To initiate Price submission, the LF Application connects and logs on to the Trading System via the LF API and the ATI WS. The LF API passes Authentication Information to the ATI WS, which in turn passes the Authentication Information to the Trading System. A Session between the LF Application and the ATI WS via the LF API is created upon successful authentication to the EBS Spot Trading System.

After a Session is created the LF Application may subscribe for Market View information for a set of currency pairs. Providing the Bank is entitled to receive Market View information, the Bank can obtain Market View information for the subscribed currency pairs.

The LF Application 50 can send Price Updates for any EBS supported currency pairs. The Price Updates are converted into Quotes by the LF and passed to the ATI WS.

Quote and Deal status information is passed back from the EBS Spot Trading System to the LF API via the ATI WS to be accessed by the LF Application. The Bank can, if it chooses to, obtain this Quote and Deal status information from the LF Application for their position keeping system. The LF Application can interrupt active Quotes at any point in time by sending an empty Price.

In either the first or second embodiments, the action of generating and submitting quote messages and maintaining quotes within the matching system is dependent upon logic and parameters as will now be described.

System Parameters

System parameters are set at various points in the system, particularly in the LF application 50 and in the ATI 53.

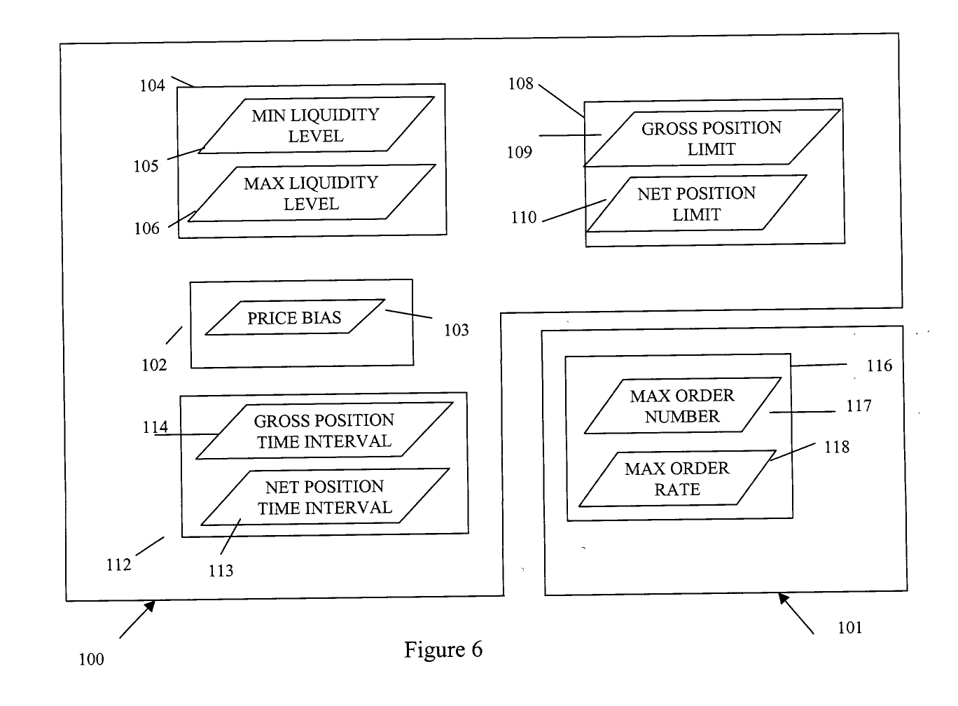

The LF application maintains a configuration file 100 that contains defaults for the following parameters, which are user configurable, as shown in FIG. 6:

a) minimum liquidity level parameter 105 in liquidity parameter store 104;

b) maximum liquidity level parameter 106 in liquidity parameter store 104;

c) list of active currency pairs;

d) gross position limit per time interval 109 in position limit store 108;

e) net position limit per time interval 110 in position limit store 108;

All parameters can be set for each tradable instrument e.g. for each currency pair in an FX system.

The ATI 53 also maintains a configuration file 101 with the following parameters:

a) maximum quote rate per second 118 in quote rate store 116.

b) Optionally, a maximum number of active quotes 117 (per currency pair) in quote rate store 116;

The parameters are used for the following purposes by the LF application 50 and ATI 53.

The LF application is configured such that it shall submit a quote (bid, offer or both, if double-sided price is specified) every time a new price is received (that is different from the current active price).

The LF application maintains multiple active quotes per currency pair.

The sum of all active quotes shall not exceed the maximum liquidity level 106 at any time.

The LF application shall submit a new quote when the sum of all active quotes for a specific currency pair and a specific side of the market falls below the minimum liquidity level 105 and the price is not changing.

The ATI shall not submit a new quote if the maximum number of active quotes is equal to the maximum 117 specified by configuration parameters.

The LF application shall calculate customer's gross and net exposure throughout the session, which is the total amount, traded in a single currency pair disregarding the sides of the market i.e. it is:

Gross position is D_{b}+Dₒ+Q_{b}+Qₒ+P_{b}+Pₒ

where D_{b} is the sum of done Deals on Bid side, Dₒ is the sum of done Deals on Offer side, Q_{b} is the sum of active quotes on bid side, Qₒ is the sum of active Quotes on Offer side, P_{b} is the potential (about to be submitted) Quote on Bid side, Pₒ is the potential (about to be submitted) Quote on Offer side

The net position limit is the total amount traded in a single currency pair taking into account the sides of the market over a Bank defined Net Position Time Interval. The Net Position is calculated as:

MAX(|D_{b}−Dₒ|+Q_{b}+P_{b}, |Dₒ−D_{b}|+Qₒ+Pₒ)

where D_{b} is the sum of done Deals on Bid side, Dₒ is the sum of done Deals on Offer side, Q_{b} is the sum of active quotes on bid side, Qₒ is the sum of active Quotes on Offer side, P_{b} is the potential (about to be submitted) Quote on Bid side, Pₒ. is the potential (about to be submitted) Quote on Offer side. Of course, other calculations of net position could be used.

Note that calculations should be done for a specific time interval that can be different for gross and net calculations and for a specific currency pair.

The Gross exposure shall not exceed the gross limit 109 per time interval 114 set in configuration file at any time during the session.

The Net exposure shall not exceed the net limit 110 per time interval 113 set in configuration file at any time during the session.

The LF application shall interrupt all outstanding quote(s) if a new price (different for the current active price) is received and submit a new quote.

The LF application shall interrupt all outstanding quotes for the specific pair when “Price-no-info” price is received for this pair.

The LF provides means for customer application to submit a price (single-sided or double-sided).

System Processes

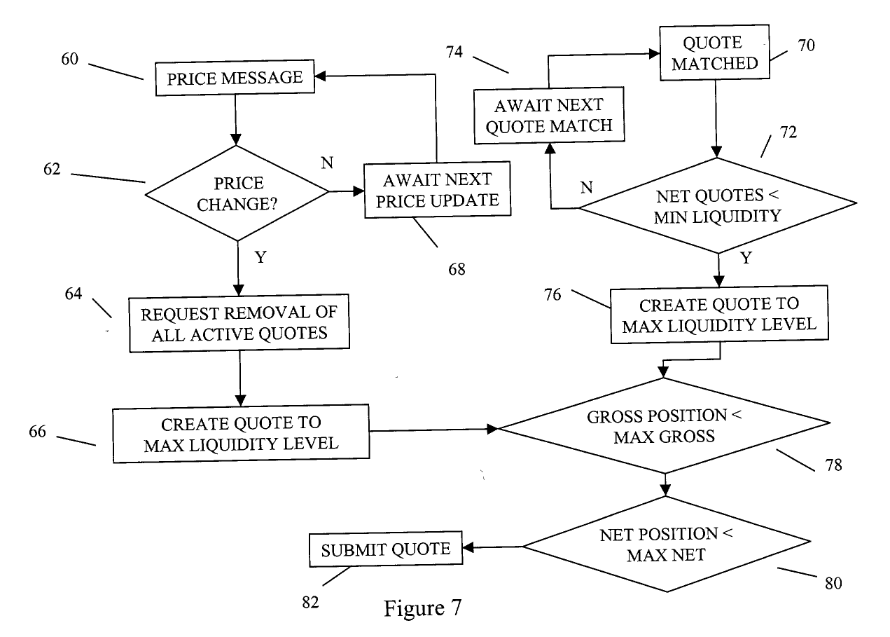

The main process of quote message generation and submission is shown in FIG. 7.

The process starts with a trading entity's price engine sending a single or double-sided price message to the quote submission interface 30, particularly the LF Application 50 (regardless of accepted currency pair subscriptions). The LF Application 50 uses prices to generate and submit quote messages provided that the criteria above are met.

Only Quotes that originate from a single price message from the Trading entity's LF application are active within the matching System at any point in time. The LF API 52 will perform several validation, liquidity and position checks on the received Price Update. Price validation is based on instrument definitions, which are part of the trading system configuration. Configuration Parameters used for checks are stored in a LF API Configuration file.

Depending on the outcome of the price validation, the Price Update is:

Accepted if both Prices are either numeric or empty Prices (a.k.a. Price-no-Info Prices);

Rejected, all active quotes removed and the session disconnected if at least one Price is non-numeric, or if both Prices (in the same Price Update) are inverted.

Note: Choice Prices are allowed.

The Price for each side of the market is processed individually and as follows:

When the Price Message is received at step 60, is accepted and the Price is determined at step 62 not equal to the previous price, then the LF API will: request the removal (interrupt) at step 64 of all active Quotes in the market for that currency pair and side of the market, and create a Quote request at step 66 for the amount specified in the Maximum Liquidity Level parameter 106 for that currency pair. The liquidity level is subsequently maintained between the Minimum and Maximum Liquidity Levels for this currency pair and side of the market by submitting additional Quote requests.

When the Price Update is received, is accepted and the Price is equal to the previous price at step 68, then the original Quote remains in the EBS Spot Trading System in order to retain its original queue position. The LF API will: wait for the next Price Update; and subsequently maintain the liquidity level between the Minimum and Maximum Liquidity Levels for this currency pair and side of the market by submitting additional Quote requests.

Before a Quote Request is actually submitted to the ATI WS, a Gross Position Check 78 and Net Position Check 80 is performed. If the Quote request fails the Position Checks then the LF issues a non-fatal error and waits for the Gross/Net Position Time Interval to elapse.

The LF will create successive multiple Quote requests resulting from a single price when the Liquidity Level (Ref: Liquidity Level Check) falls below a Bank defined Minimum Liquidity Level. This happens at step 70 whenever a pending quote is matched in whole or in part. If at step 72 it is determined that the sum of the amounts of all active quotes would fall below the minimum liquidity level parameter, then a quote is created to restore the sum of the amounts of all active quotes to maximum liquidity level (by submitting a quote that it is the difference between the pending sum of quotes and the maximum liquidity level).

The ATI WS 53 will then perform additional checks on the Quote request based on the EBS Price Formatting Rules and the number of Quotes received per second (Quotes received Throttle—FIG. 5) before submitting the request to the EBS Trading System. If the Quotes received by the ATI WS fail any of the ATI WS checks then the ATI WS will reject the Quote and wait for the next valid Quote.

Interrupt Quotes: The LF API 52 will also interrupt all Quotes for a currency pair when an Empty Price for that currency pair is received by the LF.

Send Empty Price: a.k.a. Price-No-Info. The trading entity may send an empty price for a currency pair when: the Quotes are to be interrupted, or the prices are stale or the Bank no longer wishes to trade in that currency pair.

Liquidity Level Check: As deals are executed against Quotes, the remaining Quote amount falls. When the sum of the remaining Quotes fall below a Bank defined Minimum Liquidity Level for a given currency pair, then the LF API will submit a successive Quote request for that side of the market for the amount equaling the difference between the Maximum Liquidity Level and the sum of quotes. All calculations are performed per side of the Market per currency pair. The Liquidity Level are defined per currency pair.

Gross Position Check: Every time a quote is about to be submitted the Gross Position Check is performed at step 78. This check compares the amount traded in a single currency pair disregarding the sides of the market over a time interval with the Bank defined Gross Position parameter. The amount traded includes the Done Deals+Active Quotes+potential Quotes (i.e. Quotes about to be submitted), as previously defined.

Net Position Check: Every time a quote is about to be submitted the Net Position Check is performed at step 80. This check compares the total amount traded in a single currency pair taking into account the sides of the market i.e. Bids and Offers are netted over a time interval with the Bank defined Net Position parameter.

Provided that all these checks pass, the LF API generates a quote message and transmits this to the ATI WS.

The ATI WS Then Checks:

Validation of Instrument e.g. currency pair;

Syntax Validation of Quote Price (format) such as Number of decimals after the decimal point, last Pip's value must be equal to 0 or 5 for 3-Pip currency pairs; Off-Market Prices (Bid must be within a range determined using EBS Best Dealable Bid; Offer Bid must be within a range determined using EBS Best Dealable Bid);

Inverted Prices

Quotes Received Throttle that is defined per currency pair.

The actual price of the quote submitted may be configured according to a pre-configured bias parameter 103 from a price parameter store.

Quote Bias

The Bias parameter specifies the bias amount by which a general price is to be adapted for a market maker and are expressed for general bid prices as the bid price less N pips and for general offer prices as the offer price plus M pips (where N and M are integers and pips is the term used for digits a defined number of places after the decimal point). A Dealer at a market maker may alter the values of N and M at any time by amending his Bias parameter. Preferably, N and M are constrained to avoid the possibility of inverted prices. When a new Bias parameter is received by the interface 30 it immediately applies the new values of bias to new quote messages. Any existing submitted quote messages are first interrupted.

To allow market makers to monitor the market in which they are trading, the dealable and best prices available for each currency pair may be communicated to the market maker workstation by the market maker Broker Node. A market maker dealer at the market maker workstation 20 may modify the Bias parameter to alter the bid-bias to be subtracted from a bid price and the offer-bias to be added to an offer price for each instrument and also modify the filter parameters to control the general price. The market maker's exposure to the market may, therefore, be controlled by one or more of their Dealers. Typically, a Bias parameter would be updated 2 to 3 times per day.

However, in times of price volatility, a market maker dealer may continuously monitor market prices and alter Bias parameter on a more regular basis.

1. A method of operating a computer trading interface arranged to convert price messages to quote messages for submission to an automated trading system, comprising at the computer trading interface:
receiving a price message feed in which price messages each specifying a feed price for a tradeable instrument are supplied;
determining whether a quote message should be generated and submitted based on at least the feed prices indicated in the price messages;
deriving a quote amount from at least one amount parameter; and
generating a quote message including a quote price and said quote amount for submission to the automated trading system.

2. A method according to claim 1, wherein the step of determining whether a quote message should be generated for a given price message comprises determining whether the price specified in said given price message differs from the price specified in the preceding price message and, if so, causing a quote message to be generated.

3. A method according to claim 1, wherein the step of determining whether a quote message should be generated for a given price message comprises determining whether the price specified in said given price message differs from the price specified in the preceding price message and, if so, the method further comprising causing existing unmatched quote messages to be cancelled from the trading system.

4. A method according to claim 1, wherein the quote amount parameter is a definable liquidity amount.

5. A method according to claim 1, further comprising determining a gross exposure as a sum of amounts in deals done and at least pending unmatched quote messages and preventing submission of quote messages when a definable maximum gross position is reached.

6. A method according to claim 1, further comprising determining a net exposure as a sum of net amounts in deals done and at least pending unmatched quote messages and preventing submission of quote messages when a definable maximum net position is reached.

7. A computer trading interface for converting price messages to quote messages for submission to an automated trading system, comprising:
a price feed receiver arranged to receive a price message feed in which price messages each specifying a feed price for a tradable instrument are supplied;
a price to quote converter arranged to determine whether a quote message should be generated and submitted based on at least the feed prices indicated in the price messages, and if it is so determined, to derive a quote amount from at least one amount parameter and to generate a quote message including a quote price and said quote amount for submission to the automated trading system; and
a quote submission function for submitting the quote to the trading system.

8. A computer trading interface according to claim 7, wherein the price to quote converter is arranged to determine whether a quote message should be generated for a given price message by determining whether the price specified in said given price message differs from the price specified in the preceding price message and, if so, to cause a quote message to be generated.

9. A computer trading interface according to claim 7, wherein the price to quote converter is arranged to determine whether a quote message should be generated for a given price message by determining whether the price specified in said given price message differs from the price specified in the preceding price message and, if so, to cause existing unmatched quote messages to be cancelled from the trading system.

10. A computer trading interface according to claim 7, wherein the quote amount parameter is a definable liquidity amount.

11. A computer trading interface according to claim 7, wherein the price to quote converter is further arranged to determine a gross exposure-as a function of amounts in deals done and at least pending unmatched quote messages, and to prevent submission of quote messages when a definable maximum gross position is reached.

12. A computer trading interface according to claim 7, wherein the price to quote converter is further arranged to determine a net exposure as a function of net amounts in deals done and at least pending unmatched quote messages, and to prevent submission of quote messages when a definable maximum net position is reached.

13. A computer trading interface according to claim 7, wherein the price feed receiver and price to quote converter are operated on a computer under the control of a trading entity, and the quote submission function is operated on a computer under the control of the provider of the automated trading system.

14. A computer trading interface according to claim 7, wherein the quote submission function is arranged to restrict the rate of submission of quotes to the trading system.

15. A method of operation a computer trading interface arranged to convert prices messages to quote messages for submission to an automated trading system, comprising, at the computer trading interface:
receiving a price message feed in which price messages each specifying a feed price for a tradable instrument are supplied;
receiving quote match messages from the trading system indicating quotes that have been matched;
determining whether a quote message should be generated and submitted based on previously submitted quote messages, quote match messages and a quote level parameter;
deriving a quote amount from a quote amount parameter, previously submitted quote messages and quote match messages; and
generating a quote message including a quote price and said quote amount for submission to the trading system.

16. A method according to claim 15, wherein the quote level parameter is a minimum liquidity level, and the step of determining whether a quote message should be generated and submitted comprises determining whether the sum of quote amounts specified in previously submitted but unmatched quote messages has fallen below the minimum liquidity level.

17. A method according to claim 15, wherein the quote amount parameter is a maximum liquidity level, and the step of deriving a quote amount comprises taking the difference between the maximum liquidity level and the sum of quote amounts specified in previously submitted but unmatched quote messages.

18. A method according to claim 15, further comprising determining a gross exposure as a function of amounts specified in received quote match messages and at least submitted but unmatched quote messages and preventing submission of quote messages when a definable maximum gross position is reached.

19. A method according to claim 15, further comprising determining a net exposure as a function of net amounts specified in received quote match messages and at least submitted but unmatched quote messages and preventing submission of quote messages when a definable maximum net position is reached.

20. A computer trading interface for converting price messages to quote messages for submission to an automated trading system, comprising:
a price feed receiver arranged to receive a price message feed in which price messages each specifying a feed price for a tradable instrument are supplied;
a price to quote converter arranged to receive quote match messages from the trading system indicating quotes that have been matched, to determine whether a quote message should be generated and submitted based on previously submitted quote messages, quote match messages and a quote level parameter, to derive a quote from a quote amount parameter, previously submitted quote messages and quote match messages, and to generate a quote message including a quote price and said quote amount for submission to the trading system; and
a quote submission function for submitting the quote to the trading system.

21. A computer trading interface according to claim 20, wherein the quote level parameter is a minimum liquidity level, and the price to quote converter is arranged to determine whether a quote message should be generated and submitted by determining whether the sum of quote amounts specified in previously submitted but unmatched quote messages has fallen below the minimum liquidity level.

22. A computer trading interface according to claim 20, wherein the quote amount parameter is a maximum liquidity level, and the price to quote converter is arranged to derive a quote amount by taking the difference between the maximum liquidity level and the sum of quote amounts specified in previously submitted but unmatched quote messages.

23. A computer trading interface according to claim 20, wherein the price to quote converter is further arranged to determine a gross exposure as a function of amounts in deals done and at least pending unmatched quote messages, and to prevent submission of quote messages when a definable maximum gross position is reached.

24. A computer trading interface according to claim 20, wherein the price to quote converter is further arranged to determine a net exposure as a function of net amounts in deals done and at least pending unmatched quote messages, and to prevent submission of quote messages when a definable maximum net position is reached.

25. A computer trading interface according to claim 20, wherein the price feed receiver and price to quote converter are operated on a computer under the control of a trading entity, and the quote submission function is operated on a computer under the control of the provider of the automated trading system.

26. A computer trading interface according to claim 20, wherein the quote submission function is arranged to restrict the rate of submission of quotes to the trading system.

27. A method according to claim 1 or claim 15, wherein the quote price is equal to the feed price.

28. A method according to claim 1 or claim 15, wherein the quote price is equal to the feed price adjusted by a bias parameter.

29. A method of operating a computer trading interface arranged to convert price messages the quote messages for submission to an automated trading system, comprising at the computer trading interface:
receiving a price message feed in which price messages each specifying a feed price for a tradable instrument are supplied;
deriving a quote price as a function of said feed price and a bias parameter;
deriving a quote amount as a function of at least a quote amount parameter; and
generating a quote message including said quote price and said quote amount for submission to the automated trading system.

30. A method according to claim 29, wherein the quote price is an offer price and the step of deriving comprises adding a bias parameter M to the feed price.

31. A method according to claim 29, wherein the quote price is a bid price and the step of deriving comprises subtracting a bias parameter M from the feed price.

32. A computer trading interface arranged to convert price messages to quote messages for submission to an automated trading system comprising:
a price feed receiver arranged to receive a price message feed in which price messages each specifying a feed price for a tradable instrument are supported;
a price to quote converter arranged to derive a quote price as a function of said feed price and a quote amount as a function of at least a quote amount parameter, and to generate a quote message including said quote price and quote amount; and
a quote submission function for submitting the quote to the trading system.

33. A computer trading interface according to claim 32, wherein the quote price is an offer price and the price to quote converter is arranged to derive the quote price by adding a bias parameter M to the feed price.

34. A computer trading interface according to claim 32, wherein the quote price is a bid price and the price to quote converter is arranged to derive the quote price by subtracting a bias parameter N from the feed price.

35. A computer trading interface arranged to convert price messages to quote messages for submission to an automated trading system, comprising:
a price feed receiver arranged to receive a price message feed;
a price to quote converter arranged to convert received price messages to quote messages;
a quote submission function arranged to submit quotes to the trading system; and
said price to quote converter including a user configurable parameter store for storing at least a quote price parameter and a quote amount parameter, and being configured to derive quote prices and quote amounts based on received price messages and said quote price parameter and/or said quote amount parameter.

36. A computer trading interface according to claim 35, wherein the price feed receiver and price to quote converter are operated on a computer under control of a trading entity, and the quote submission function is associated with the automated trading system.

37. A computer trading interface according to claim 35, wherein the quote submission function is arranged to restrict the rate of submission of quotes, to one quote per configurable time interval.

38. A computer trading interface according to claim 35, wherein the quote submission function is arranged to prevent quote submission if the quote price is outside a given range.

39. A computer trading interface according to claim 35, wherein the quote submission function is arranged to prevent quote submission if a quote to bid is inverted in price with a quote to offer.

40. A computer trading interface according to claim 36, wherein the price to quote converter and quote submission function communicate with one another by exchanging messages to and from one another.

41. A computer trading interface according to claim 36, wherein the price to quote converter provides quote messages to the quote submission function, and the quote submission function is further arranged to provide deal status messages to the price to quote converter.

42. A computer trading interface according to claim 36, wherein the automated trading systems provides market data to the Trading entity.

43. A computer trading interface according to claim 36, wherein the automated trading system provides market data only to those trading entities entitled by a combination of messages and function calls.
